(19) United States
(12) Patent Application Publication
(10) Pub. No.: US 2013/0293103 A1
(43) Pub. Date: Nov. 7, 2013

(54) High Efficiency 3-Way Halogen Lamp With Single Filament Microprocessor Driven Light Sources

(71) Applicants: Ernest C. Weyhrauch, Richmond, KY (US); James E. Oetken, Winchester, KY (US); George B. Kendrick, Lexington, KY (US)

(72) Inventors: Ernest C. Weyhrauch, Richmond, KY (US); James E. Oetken, Winchester, KY (US); George B. Kendrick, Lexington, KY (US)

(73) Assignee: OSRAM SYLVANIA Inc., Danvers, MA (US)

(21) Appl. No.: 13/464,028

(22) Filed: May 4, 2012

(51) Int. Cl. H01J 7/44

(52) U.S. Cl. 315/52

(57) ABSTRACT

A 3-way halogen lamp selectively generates a first light level, second light level, and third light level based on whether a first terminal on the lamp base and a second terminal on the lamp base are connected to a power supply. A controller housed entirely within the based detects whether the first and second terminals are connected to the power supply, and generates a control signal as a function thereof. A switching circuit housed entirely within the base is operated by the control signal to provide a voltage load signal having a particular RMS voltage. A single filament halogen capsule is attached to the base and connected to the switching circuit for receiving the voltage load signal and generating the first light level, second light level, and third light level when the voltage signal has a first RMS voltage, a second RMS voltage, and a third RMS voltage, respectively.

### BACKGROUND

The present disclosure relates to a 3-way lamp that generates a first light level, a second light level, and a third light level with a single filament halogen capsule.

### PRIOR ART

A standard 3-way lamp is configured to selectively generate three light levels (e.g., a low light level, a mid light level, and a high light level) when it is used in a 3-way lamp fixture. The standard 3-way lamp is typically marketed by wattage levels. For example, a 3-way incandescent lamp may be marketed as operating at a 30 Watt/305 lumen level, a 70 Watt/995 lumen level, and a 100 Watt/1300 lumen level. In contrast to a lamp fixture having a socket with two terminals for energizing a lamp at one, single light level, a 3-way lamp fixture has a specifically designed socket (“3-way socket”) with three terminals. The three terminals include two power supply terminals (i.e., first power supply terminal and second power supply terminal) and a neutral terminal. Accordingly, a standard 3-way lamp has a base with three input terminals for connecting with each of the three terminals of the 3-way socket.

In order to achieve three different light levels, the standard 3-way lamp has two filaments. One filament is connected to the first power supply terminal and is designed to operate at the low wattage rating. The other filament is connected to the second power supply terminal and is designed to operate at the mid wattage rating. During the low level light operation, power is supplied only to the first power supply terminal of the two power supply terminals. And, thus, only the first filament of the two filaments produces light. During the mid level light operation, power is supplied only to the second power supply terminal of the two power supply terminals. And, thus, only the second filament of the two filaments produces light. During the high level light operation, power is supplied to both the first and second power supply terminals, and thus, the first and second filaments both produce light. This design and operation of a standard incandescent 3-way lamp using two filaments is described in U.S. Pat. No. 5,239,233.

The design and operation of a 3-way halogen lamp having two filaments is described in U.S. Pat. No. 6,919,684. However, placing two filaments in a halogen capsule, such as a 120 Volt halogen capsule, makes it highly likely that the filaments will come in contact with each other due to shock or vibration. U.S. Pat. No. 4,654,560 discloses a halogen lamp with two filaments, a tungsten filament and a ballast filament. The ballast filament is used to limit the current to the tungsten filament. This arrangement is not energy efficient.

The following are also know in the prior art: U.S. Pat. Nos. 6,445,133 (Lin et al), 5,356,314 (Aota), 7,166,964 (Weyhrauch et al), 3,836,814 (Rodriquez), and US Patent Application Publication No. 2005/0110438 (Ballenger, Weyhrauch).

### SUMMARY

In one embodiment, a single filament halogen lamp provides three lighting levels: a first light level (e.g., low), a second light level (e.g., mid), and a third light level (e.g., high). In particular, the lamp includes a base having a first lamp terminal and a second lamp terminal that are each configured for selectively connecting to a power supply. When the first lamp terminal is connected to the power supply, the first lamp terminal receives a first input voltage waveform from the power supply. When the second lamp terminal is connected to the power supply, the second lamp terminal receives a second input voltage waveform from the power supply.

A controller is housed entirely within the base and connected to the first lamp terminal and the second lamp terminal. The controller is configured to detect whether the first lamp terminal is connected to the power supply, and whether the second lamp terminal is connected to the power supply. Thus, the controller is configured to detect the input lamp terminal configuration status: only the first lamp terminal of the lamp terminals is connected to the power supply; only the second lamp terminal of the lamp terminals is connected to the power supply; and both the first and the second lamp terminals are connected to the power supply. The controller is further configured to generate a control signal as a function of the detected input lamp terminal configuration.

A switching circuit is also housed entirely within the base. The switching circuit is connected to the controller and is operated by the control signal in order to provide a voltage load signal having a particular RMS voltage. More specifically, the voltage load signal has a first RMS voltage when only the first lamp terminal of the first and second lamp terminals is connected with the power supply, wherein the voltage load signal has a second RMS voltage when only the second lamp terminal of the first and second lamp terminals is connected with the power supply, and wherein the voltage load signal has a third RMS voltage when the first and second lamp terminals are both connected with the power supply. A single filament halogen capsule is attached to the base and connected to the switching circuit for receiving the voltage load signal therefrom. The single filament halogen capsule generates the first light level when the voltage load signal has the first RMS voltage, and generates the second light level when the voltage load signal has the second RMS voltage load, and generates the third light level when the voltage load signal has the third RMS voltage.

Other objects and features will be apparent and pointed out hereinafter.

### BRIEF DESCRIPTION OF THE DRAWINGS

FIG. 1 is a cross section of a single filament, 3-way lamp in accordance with one embodiment.

FIG. 2 is a cross section of a single filament, 3-way lamp in accordance with one embodiment.

FIG. 3 is a block diagram of a voltage conversion circuit for use in a single filament, 3-way lamp in accordance with one embodiment.

FIG. 4 is a voltage waveform illustrating principles of phase clipping.

FIGS. 5A-5C each illustrate an exemplary output waveform generated by the voltage conversion circuit of FIG. 3 in accordance with one embodiment.

Corresponding reference characters indicate corresponding parts throughout the drawings.

### DETAILED DESCRIPTION

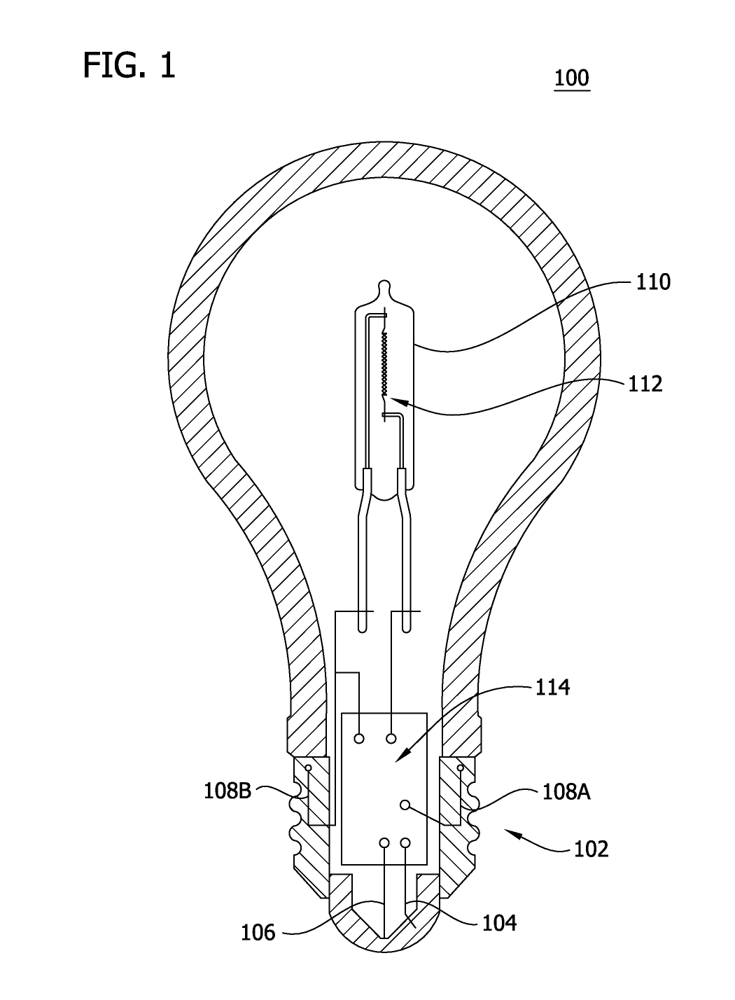

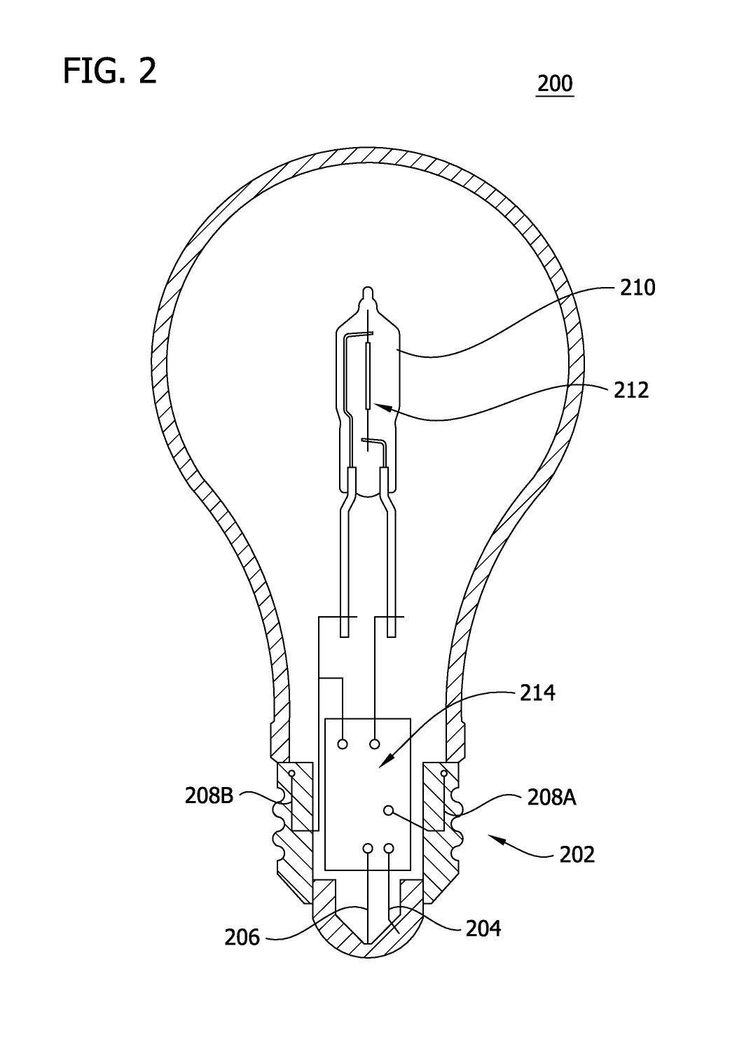

FIGS. 1 and 2 each illustrate an exemplary single filament, 3-way lamp 100, 200 in accordance with one embodiment. The lamp 100, 200 is configured to be used with a 3-way lamp fixture in order to generate a first light level, a second light level, and a third light level. In particular, the lamp includes a base 102, 202 that is arranged and adapted to fit into a lamp socket of a 3-way lamp fixture. The base 102, 202 has three lamp input terminals: a first lamp input terminal 104, 204, a second lamp input terminal 106, 206, and a third lamp input terminal 108A, 1088, 208A, 208B. The first lamp input terminal 104, 204 and the second lamp input terminal 106, 206 are each configured for selectively connecting to a power supply via the 3-way lamp fixture. The third lamp input terminal 108A, 1088, 208A, 208B is configured for connecting to a neutral potential.

In the illustrated embodiment, the first lamp input terminal 104, 204 and the second lamp input terminal 106, 206 are located on a bottom surface of the base 102, 202 for interfacing with the lamp socket. In one embodiment, the first lamp input terminal 104, 204 (e.g., base ring terminal) is a ring-shaped contact that is positioned off-center on the bottom surface of the base 102, 202. The second lamp input terminal 106, 206 (e.g., base eyelet terminal) is a contact that is generally positioned in the center of the bottom surface of the base 102, 202. Although the first lamp input terminal 104, 204 and the second lamp terminal are illustrated as the base ring terminal and the base eyelet terminal, respectively, it should be noted that the first lamp input terminal 104, 204 may be the base eyelet terminal and the second lamp input terminal 106, 206 may be the base ring terminal. The first lamp input terminal 104, 204 and the second lamp input terminal 106, 206 are configured for connecting to an alternating current (“AC”) line voltage, such as 120 Volts, and receiving an input voltage waveform therefrom. The base 102, 202 of the lamp includes a threaded metal shell for securing the base 102, 202 into the lamp socket. The threaded metal shell forms the third lamp input terminal 108A, 108B, 208A, 208B (e.g., neutral terminal).

A light emitting envelope is attached to the base 102, 202 and houses a light emitting element. In particular, the light emitting envelope is a halogen capsule 110, 210 and the light emitting element is a single filament 112, 212 housed within the halogen capsule 110, 210. For example, as shown in FIG. 1, the lamp 100 may be an A-Line heavy-wall lamp, such as the Sylvania Capsylite A19 halogen light bulb. Alternatively, as shown in FIG. 2, the lamp 200 may be an A-Line thin-wall lamp, such as the Sylvania HALOGEN Supersaver® light bulb. It should be noted that the scope includes other single filament halogen capsule lamps and is not limited to the illustrated embodiments.

The lamp 100, 200 includes a voltage conversion circuit (illustrated generally in FIGS. 1 and 2 as 114 and 214, respectively) connected between the lamp input terminals 104, 106, 204, 206 and the single filament 112, 212. In one embodiment, the voltage conversion circuit 114, 214 is housed entirely within the base 102, 202 of the lamp 100, 200. The voltage conversion circuit 114, 214 is configured to detect a connection configuration of the input terminals 104, 106, 204, 206 and adjust one or more of the input voltage waveform(s) received via the lamp input terminals 104, 106, 204, 206 in order to generate three voltage levels for operating the single filament 112, 212. In other words, the voltage conversion circuit 114, 214 detects whether each, or both, of the input terminals 104, 204 and 106, 206 is connected to the power supply and generates a load voltage having a voltage level as a function thereof. The single filament 112, 212, in turn, is able to produce three different light levels.

In one embodiment, when the first lamp input terminal 104, 204 is connected to the power supply (e.g., AC line voltage), the first lamp input terminal 104, 204 receives a first input voltage waveform having a first RMS initial voltage. The voltage conversion circuit 114, 214 generates a first load voltage waveform having a first RMS load voltage as a function of the first input voltage waveform. Similarly, when the second lamp input terminal 106, 206 is connected to the power supply (e.g., AC line voltage), the second lamp input terminal 106, 206 receives a second lamp input voltage waveform having a second RMS initial voltage. The voltage conversion circuit 114, 214 generates a second load voltage waveform having a second RMS load voltage as a function of the second load voltage waveform. When the first and the second lamp input terminals 104, 106, 204, 206 are simultaneously connected to the power supply, the voltage conversion circuit 114, 214 receives a third lamp input voltage waveform having a third RMS initial voltage. The voltage conversion circuit 114, 116 generates a third load voltage waveform having a third RMS load voltage as a function of the third lamp input voltage waveform. In one embodiment, the first, second, and third RMS load voltages are different from each other. As such, the lamp generates a first, second, and third light level in response to receiving the first, second, and third load voltage waveforms, respectively.

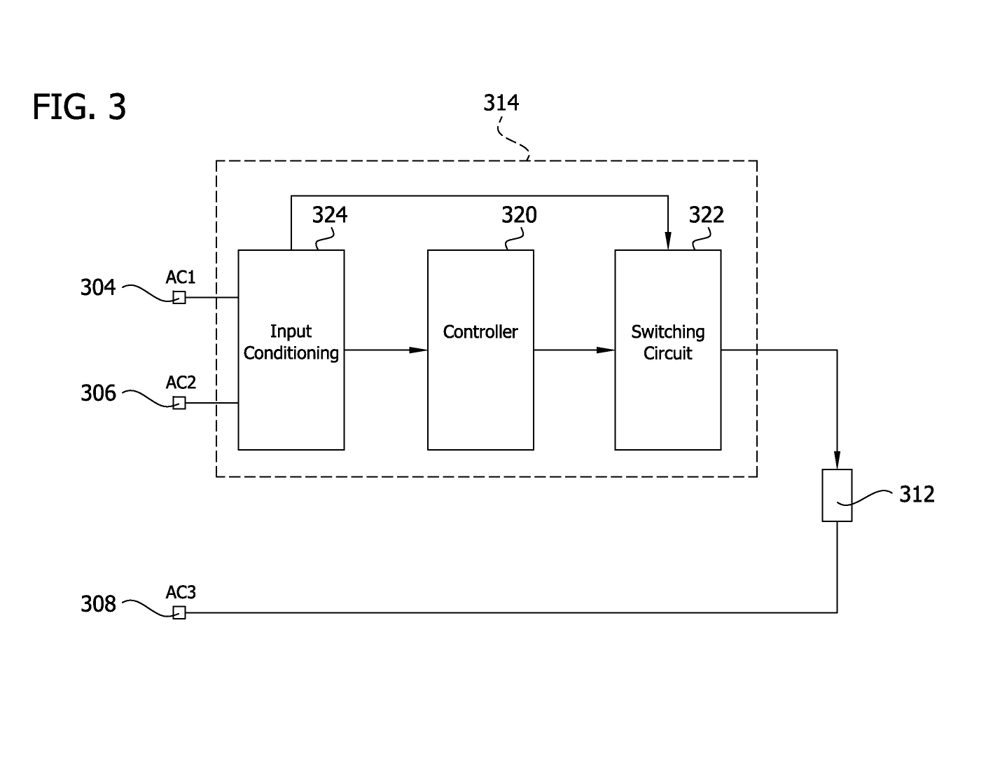

Referring to FIG. 3, in one embodiment, the voltage conversion circuit 314 includes a controller 320 (e.g., microprocessor, microcontroller) and a switching circuit 322. The controller is connected to the first and second lamp input terminals 304, 306, and the switching circuit 322 is connected between the controller 320 and the single filament halogen capsule 312. The controller 320 is configured to detect whether each, or both, of the first and second lamp input terminals, 304 and 306 is connected to the power supply, and to generate a control signal as a function thereof. Thus, the controller 320 generates a first control signal when it detects that only first lamp input terminal 304 of the lamp input terminals 304 and 306 is connected to the power supply. The controller 320 generates a second control signal when it detects that only second lamp input terminal 306 of the lamp input terminals 304 and 306 is connected to the power supply. And, the controller 320 generates a third control signal when it detects that the first lamp input terminal 304 and the second lamp input terminal 306 are both connected to the power supply.

The switching circuit 322 receives the control signal generated by the controller 320 is operated accordingly. In particular, the switching circuit 322 generates a voltage load signal having a particular root mean square (RMS) voltage that corresponds to the received control signal. Thus, the switching circuit 322 generates a voltage load signal having a first RMS voltage when it receives the first control signal (e.g., when only the first lamp input terminal 304 is connected to the power supply); the switching circuit 322 generates a voltage load signal having a second RMS voltage when it receives the second control signal (e.g., when only the second lamp input terminal 306 is connected to the power supply); and the switching circuit 322 generates a voltage load signal having a third RMS voltage when it receives the third control signal (e.g., when both the first and the second lamp input terminals, 304 and 306, are connected to the power supply). The single filament halogen capsule 312 is connected to the switching circuit 322 for receiving the voltage load signal therefrom. The single filament halogen capsule 312 generates the first light level when the voltage load signal has the first RMS voltage, and generates the second light level when the voltage load signal has the second RMS voltage load, and generates the third light level when the voltage load signal has the third RMS voltage.

In the illustrated embodiment, the voltage conversion circuit 314 includes an input conditioning circuit 324 for differentiating the input voltage received from the power supply when the first lamp input terminal 304 is the only lamp input terminal (304, 306) connected to the power supply from the input voltage received from the power supply when the second lamp input terminal 306 is the only lamp input terminal (304, 306) connected to the power supply. The input conditioning circuit 324 may also include electromagnetic interference (EMI) filtering/protection circuitry as generally known in the art. In one embodiment, the input conditioning circuit 324 includes a resistive network connected to the first input terminal 304 and/or the second input terminal 306, and to the controller 320. The resistive network adjusts (e.g., increases, decreases) the input voltage from the power supply that is provided to the controller 320 so that it has one value (i.e., range, threshold value) when the input voltage is received via the first input terminal 304 and has a second value (i.e., range, threshold value), that is different from the first value, when the input voltage is received via the second input terminal 306. Accordingly, the controller 320 detects that the first lamp input terminal 304 is the only lamp input terminal (304, 306) connected to the power supply when the input voltage received by the controller 320 has the first value, and controller 320 detects that the second lamp input terminal 306 is the only lamp input terminal (304, 306) connected to the power supply when the input voltage received by the controller 320 has the second value. When both the input lamp terminals, 304 and 306, are connected to the power supply, input voltage is received via both input lamp terminals 304 and 306, and thus the input voltage has a third value that is a combination of the first and second values. The controller 320 detects that the first lamp input terminal 304 and the second lamp input terminal 306 are both connected to the power supply when the input voltage received by the controller has the third value.

In one embodiment, the switching circuit 322 operates in one of a non-conductive state and a conductive state, as a function of the control signal, in order to generate a load voltage signal having a particular RMS voltage from the input voltage signal. When the switching circuit 332 operates in the non-conductive state, the input voltage signal is not conducted to the single filament halogen capsule 312; and when the switching circuit 332 operates in the conductive state, the input voltage signal is conducted to the single filament halogen capsule 312. Thus, when the switching circuit 332 operates in the non-conductive state, the RMS voltage of the load voltage signal is reduced from that of the input voltage signal. Accordingly, varying the amount of time that the switching circuit 332 operates in the non-conductive and conductive states adjusts the RMS voltage of the load voltage, and in turn, the light level produced therefrom.

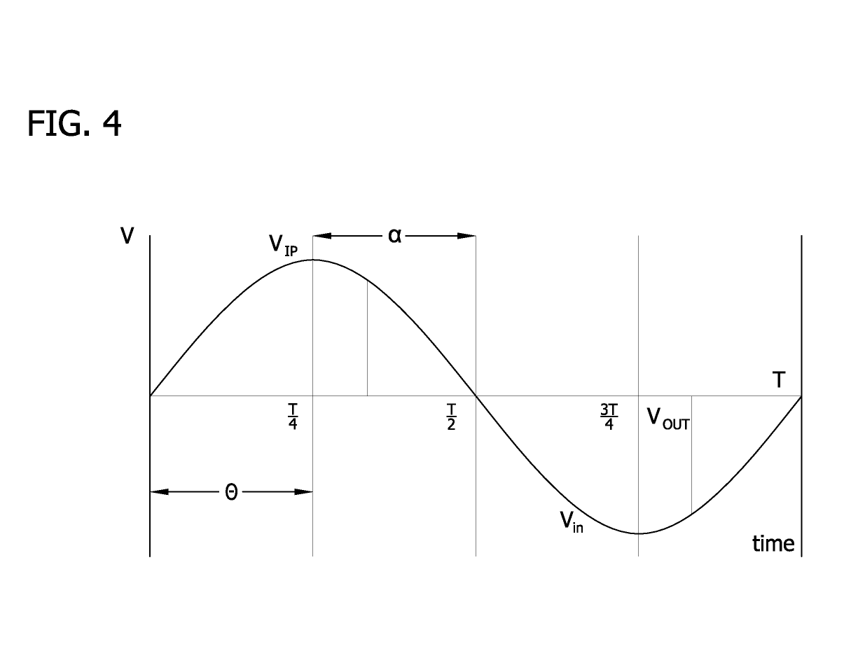

In one embodiment, the switching circuit 332 may be a phase clipping circuit configured to receive the input voltage signal from the lamp input terminals 204, 306, and to receive the control signal from the controller 320. Referring to FIG. 4, as generally known by one of ordinary skill in the art, a phase clipping circuit includes a TRIAC (Triode for Alternating Current) that has a conductive mode and a non-conductive mode. Clipping is characterized by a conduction angle α, and a delay angle θ. The conduction angle is the phase between the point on the input voltage waveform where the TRIAC begins conducting and the point on the input voltage waveform where the TRIAC stops conducting. Conversely, the delay angle is the phase delay between the leading line voltage zero crossing and the point where the TRIAC begins conducting. The control signal received by the phase clipping circuit 332 from the controller 320 dictates the conduction angle, and thereby the RMS voltage of load voltage signal.

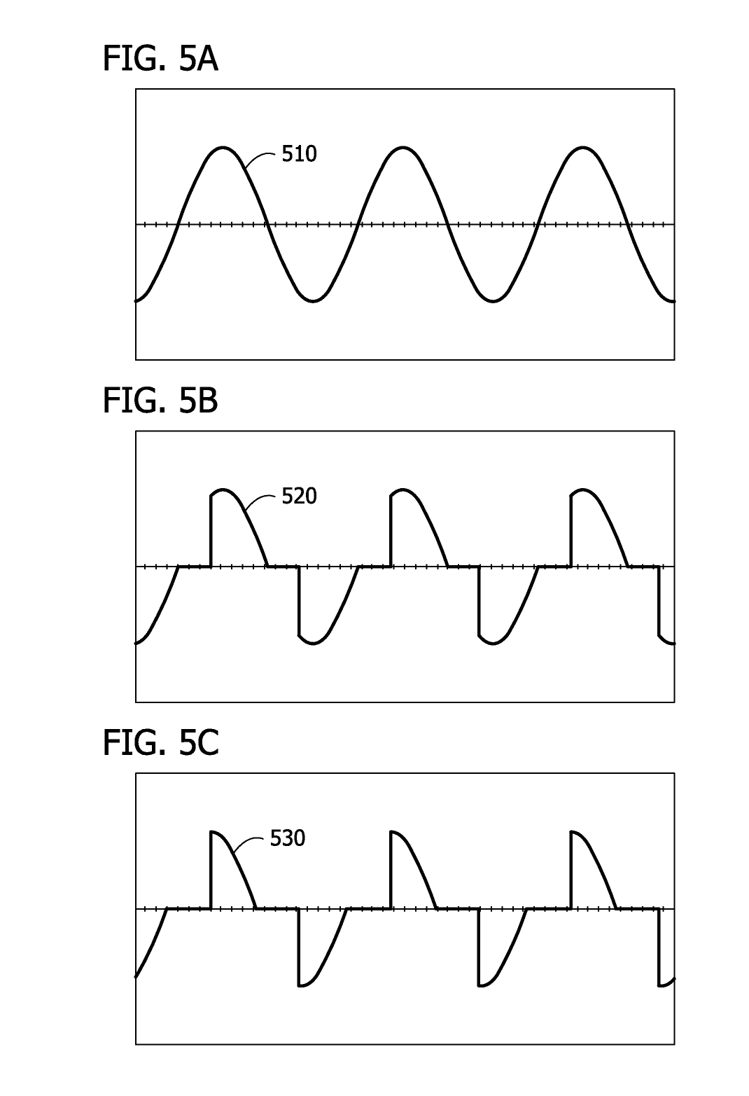

FIGS. 5A, 5B, and 5C illustrate exemplary load voltage waveforms provided by a phase clipping circuit to the single filament halogen capsule 312 in order to produce a first, a second, and a third light level responsive to the first, second, and third input terminal configurations. In particular, FIG. 5A illustrates a first load voltage waveform 510 which is provided to the single filament halogen capsule 312 in response to a first input terminal configuration receiving an input voltage waveform from the power supply. As illustrated, the first load voltage waveform 510 has conduction angle of approximately 180 degrees, with no delay, so the phase clipping circuit operates exclusively in the conductive mode during this input terminal configuration. As such, the RMS voltage of the first load voltage waveform 510 is substantially the same as the RMS voltage of the input voltage waveform. Accordingly, the first load voltage waveform 510 is provided to the single filament halogen capsule 312 and a first light level (e.g., high light level) is generated. For example, the RMS voltage of the input voltage waveform and the load voltage waveform 510 may be 120 Volts. Accordingly, for a 72 Watt lamp, the first light level would provide approximately 1500 lumens.

FIG. 5B illustrates a second load voltage waveform 520 which is provided to the single filament halogen capsule 312 in response to a second input terminal configuration receiving an input voltage waveform from the power supply. As illustrated, the second load voltage waveform 520 has conduction angle of approximately 120 degrees so the RMS voltage of the second load voltage waveform 510 is accordingly reduced from that of the input voltage waveform. As such, when the second load voltage waveform 520 is provided to the single filament halogen capsule 312, a second light level (e.g., medium light level) is generated. For example, the RMS voltage of the second load voltage waveform 520 may be approximately 107 Volts. Accordingly, for the 72 Watt lamp that provides 1500 lumens at the first light level discussed above, the light output at the second light level would be approximately 1040 lumens.

FIG. 5C illustrates a third load voltage waveform 530 which is provided to the single filament halogen capsule 312 in response to a third input terminal configuration receiving an input voltage waveform from the power supply. As illustrated, the third load voltage waveform 530 has conduction angle of approximately 90 degrees so the RMS voltage level of the third load voltage waveform 410 is accordingly reduced from that of the input voltage waveform. As such, when the third load voltage waveform 520 is provided to the single filament halogen capsule 312, a third light level (e.g., low light level) is generated. For example, the RMS voltage of the third load voltage waveform 530 may be approximately 84 Volts. Accordingly, for the 72 Watt lamp that provides 1500 lumens at the first light level discussed above, the light output at the third light level would be approximately 480 lumens. It should be noted that conduction angles, other than those specifically discussed herein, can be used based on the desired light level outputs.

In another embodiment, the switching circuit 332 is a pulse width modulation circuit having a duty cycle. As generally known to one of ordinary skill in the art, the duty cycle represents the time that the circuit spends in the conductive state as a fraction of the total time that the circuit is operated in either the conductive or the non-conductive state. Thus, the duty cycle for the pulse width modulation circuit described herein is the ratio of amount of time the circuit operates in the conductive state to the period of the input waveform. The control signal dictates the duty cycle for the pulse width modulation circuit so that the pulse width modulation circuit provides a load voltage signal with particular RMS voltage. As such, the controller 320 is configured to adjust the duty cycle for the pulse width modulation circuit via the control signal in order to vary the RMS voltage of the load voltage signal as a function of the detected input terminal configuration.

It is contemplated that there could be other configurations of the switching circuit which are used to reduce the RMS voltage of the input voltage signal in accordance with the above discussion.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the embodiments.

When introducing elements, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates by way of example and not by way of limitation. This description enables one skilled in the art to make and use the disclosure, and describes several embodiments, adaptations, variations, alternatives and uses, including what is presently believed to be the best mode of carrying out the disclosure. Additionally, it is to be understood that the disclosure is not limited in its application to the details of construction and the arrangement of components set forth in the following description or illustrated in the drawings. The disclosure is capable of other embodiments and of being practiced or carried out in various ways. In addition, it will be understood that the phraseology and terminology used herein is for the purpose of description and should not be regarded as limiting.

Having described aspects in detail, it will be apparent that modifications and variations are possible without departing from the scope of aspects as defined in the appended claims. As various changes could be made in the above constructions, products, and methods without departing from the scope of aspects, it is intended that all matter contained in the above description and shown in the accompanying drawings shall be interpreted as illustrative and not in a limiting sense.

### GLOSSARY

A non-limiting list of the above reference numerals:

| | |
|---|---|
| 100 | lamp |
| 102 | lamp base |
| 104 | first lamp input terminal |
| 106 | second lamp input terminal |
| 108A, 108B | third lamp input terminal |
| 110 | halogen capsule |
| 112 | filament |
| 114 | voltage conversion circuit |
| 200 | lamp |
| 202 | lamp base |
| 204 | first lamp input terminal |
| 206 | second lamp input terminal |
| 208A, 208B | third lamp input terminal |
| 210 | halogen capsule |
| 212 | filament |
| 214 | voltage conversion circuit |
| 304 | first lamp input terminal |
| 306 | second lamp input terminal |
| 308 | third lamp input terminal |
| 312 | filament |
| 314 | voltage conversion circuit |
| 320 | controller |
| 322 | switching circuit |
| 324 | input conditioning circuit |
| 510 | first load voltage waveform |
| 520 | second load voltage waveform |
| 530 | third load voltage waveform |

We claim:

1. A lamp (100; 200) for selectively generating at least a first light level, a second light level, and a third light level, the lamp comprising:
a base (102; 202) having a first lamp terminal (104; 204; 304) for selectively connecting with a power supply and a second lamp terminal (106; 206; 306) for selectively connecting with the power supply;
a controller (32) housed entirely within the base (102; 202) and connected to the first lamp terminal (104; 204; 304) and connected to the second lamp terminal (106; 206; 306), the controller configured to detect whether the first lamp terminal (104; 204; 304) is connected to the power supply and configured to detect whether the second lamp terminal (106; 206; 306) is connected to the power supply, and to generate a control signal as a function thereof;
a switching circuit (322) housed entirely within the base (102; 202) and connected to the controller (320), the switching circuit (322) operated by the control signal to provide a voltage load signal having a particular RMS voltage, wherein the voltage load signal has a first RMS voltage when only the first lamp terminal (104; 204; 304) of the first and second lamp terminals (104; 204; 304; 106; 206; 306) is connected with the power supply, wherein the voltage load signal has a second RMS voltage when only the second lamp terminal (106; 206; 306) of the first and second lamp terminals (104; 204; 304; 106; 206; 306) is connected with the power supply, wherein the voltage load signal has a third RMS voltage when the first and second lamp terminals (104; 204; 304; 106; 206; 306) are both connected with the power supply; and
a single filament halogen capsule (312) attached to the base (102; 202) and connected to the switching circuit (322) for receiving the voltage load signal therefrom, the single filament halogen capsule (312) generates the first light level when the voltage load signal has the first RMS voltage, and generates the second light level when the voltage load signal has the second RMS voltage load, and generates the third light level when the voltage load signal has the third RMS voltage.

2. The lamp (100; 200) of claim 1 wherein the switching circuit (322) is a phase clipping circuit.

3. The lamp (100; 200) of claim 2 wherein the phase clipping circuit includes a triode for alternating current (TRIAC).

4. The lamp (100; 200) of claim 1 wherein the switching circuit (322) is a pulse width modulation circuit.

5. The lamp (100; 200) of claim 4 wherein the pulse width modulation circuit has a duty cycle controlled by the control signal.

6. The lamp (100; 200) of claim 1 wherein the second RMS voltage is greater than the first RMS voltage.

7. The lamp (100; 200) of claim 1 wherein the first lamp terminal (104; 204; 304) is a base ring terminal and the second lamp terminal (106; 206; 306) is a base eyelet terminal.

8. The lamp (100; 200) of claim 1 wherein the first light level is a low light level, the second light level is a mid light level, and the third light level is a high light level.

9. The lamp (100; 200) of claim 1 wherein the base (102; 202) is configured to receive an input voltage waveform when at least one of the first and the second lamp terminals (104; 204; 304; 106; 206; 306) is connected to the power supply, and further comprising an input conditioning circuit (324) connected between the base (102; 202) and the controller (320) for differentiating the input voltage waveform received when the first lamp terminal (104; 204; 304) is connected to the power supply from the input voltage waveform received when the second lamp terminal (106; 206; 306) is connected to the power supply.

10. The lamp (100; 200) of claim 9 wherein the input conditioning circuit (324) includes a resistive network.

11. The lamp (100; 200) of claim 1 wherein the base (102; 202) is configured to receive an input voltage waveform having an initial RMS voltage when at least one of the first and the second lamp terminals (104; 204; 304; 106; 206; 306) is connected to the power supply, and wherein the first RMS voltage is substantially the same as the initial RMS voltage.

12. The lamp (100; 200) of claim 1 wherein the base (102; 202) is configured to receive an input voltage waveform having an initial RMS voltage when at least one of the first and the second lamp terminals (104; 204; 304; 106; 206; 306) is connected to the power supply, and wherein each of the first RMS voltage, the second RMS voltage, and the third RMS voltage is less than the initial RMS voltage.
